(19) United States
(12) Patent Application Publication
(10) Pub. No.: US 2009/0141019 A1
(43) Pub. Date: Jun. 4, 2009

(54) 4D REAL-WORLD BROWSING WITH CAPABILITY TO RECOGNIZE AND ACCESS OBJECTS IN REAL-TIME

(75) Inventors: Maxim Lobko, Cologne (DE); Marc Hoffmann, Dinslaken (DE); Martin Buecker, Dortmund (DE); Edmund Coersmeier, Bochum (DE)

Correspondence Address: BANNER & WITCOFF, LTD., 1100 13th STREET, N.W., SUITE 1200, WASHINGTON, DC, 20005-4051, US

(73) Assignee: NOKIA CORPORATION, Espoo (FI)

(21) Appl. No.: 11/949,215

(22) Filed: Dec. 3, 2007

(51) Int. Cl. G06T 15/00

(52) U.S. Cl. 345/419

(57) ABSTRACT

3D technologies have facilitated tremendous growth in terms of allowing real-world browsing using compositions of satellite or aerial images or static 3D models of real-world objects. Prior art approaches, however, are limited with respect to real-time capabilities. This invention responds to the noted deficiencies by providing a novel method, apparatus, and system for providing 4D (e.g., 3D+real-time) based approaches to allow users to view images or models of objects in real-time, offering users an opportunity to engage, access and interact with the objects depicted in real-time. The interaction may entail providing a user instruction as to how to complete a given task responsive to an identified problem. One or more objects may connect with a mobile/remote terminal based on application requirements and the like to facilitate such interaction and/or instruction.

### FIELD

Aspects of the invention generally relate to wireless computing technologies. More specifically, an apparatus, method and system are described for providing the ability to browse and access real-world objects in real-time.

### BACKGROUND

Improvements in computing technologies have changed the way people interact with their surrounding environment. These improvements include the development of technologies that incorporate three dimensional (3D) characteristics (e.g., the three physical dimensions of space—length, width and height) into their functionality. For example, Google Earth allows real-world browsing in 3D of various structures or objects using compositions of satellite and/or aerial images. While the incorporation of satellite and aerial images, and models, represented an advancement in the art relative to conventional mapping technologies, the images and models do not reflect real-time properties of depicted objects. For example, the images or models are typically several days old, and in some instances, even several months old or more. Movable objects may change their position or might be added and have to be modeled accordingly (e.g. laptops or mobile terminals placed in private rooms that can be remotely accessed by the respective owners). Working with and linking to static/stale data may have serious implications in time-sensitive applications (e.g., monitoring structures in the presence of dangerous weather (e.g., flooding)).

In addition to the above-identified problems associated with static/stale data, complications exist with respect to the interaction with the structure or objects depicted in the various images and models. Conventional practices involve the publication and printing of written instructions (e.g., user manuals) to direct a user how to interact with a given object. Written instructions are often complicated and difficult to understand and do not provide opportunities to adjust to a given situation at hand. In other cases, written instructions might not even be available, such as when one has borrowed a car from a friend, and the friend's car generates a warning light in the dashboard display panel.

Interfacing to the various structures and objects has proven to be problematic to users, particularly those users that are not well-versed in the electronic and computer arts. Connecting with an unknown device via some software tools can be a frustrating experience. For example, Bluetooth connectivity via a mobile terminal entails the mobile terminal collecting device names in the nearby vicinity (e.g., near field) as candidate connection partners. Choosing connection partners from the candidate connection partners can be a time-consuming experience. Even those users that are familiar with the types of connections to be established may still encounter other difficulties.

### BRIEF SUMMARY

The following presents a simplified summary of aspects of the invention in order to provide a basic understanding of some aspects of the invention. This summary is not an extensive overview, and is not intended to identify key or critical elements or to delineate the scope of the claims. The following summary merely presents some concepts and aspects of the invention in a simplified form as a prelude to the more detailed description provided below.

To overcome limitations in the prior art described above, and to overcome other limitations that will be apparent upon reading and understanding the present specification, aspects of the present invention are directed to a novel apparatus, method and system for providing access to one or more real-world objects via one or more computer platforms. Aspects may provide for four dimensional (4D) imagery and modeling, incorporating a temporal component to accompany the three physical dimensions of space. Furthermore, the temporal component may provide opportunities to engage in real-time interaction with real-world objects using one or more computer platforms. Additional aspects enable the interaction to take place via a mobile terminal or the like. Based on the interaction, instructions may be provided to perform a task.

Aspects of the invention provide real-world browsing with the capability to recognize real-world objects, and modeling scenes of the real-world objects in real-time. An interactive zoom capability may be provided to facilitate interaction with the objects. A context sensitivity associated with the objects may qualify the nature of the interaction with the objects. The context sensitivity may be used to provide instruction as to how to solve an actual object component problem associated with one or more of the objects. Security measures may be enacted to ensure secure access to the objects. A connection between the objects and a computing platform (e.g., a remote/mobile terminal) may be established based on one or more protocols and via a point-and-connect scheme.

These and other aspects of the invention generally relate to a source device (e.g., a video camera) connecting with one or more objects based on an identification of the one or more objects. The source device may shoot images live and distribute the images, or model(s) of objects contained in the images, to one or more target devices. The one or more target devices may use the images and/or models to exercise control over one or more objects depicted in the images and/or models. The source device and/or target devices may further be configured to adjust a granularity associated with the objects included in the images and/or models to enable interaction or access to take place at various levels of abstraction. The interaction or access may be facilitated by one or more interfaces and controls. The target devices may be configured to receive instructions related to how to interact with the objects. Feedback may be provided to improve the interaction capabilities.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a network computing environment suitable for carrying out one or more illustrative aspects of the invention.

FIG. 2 illustrates a data processing architecture suitable for carrying out one or more illustrative aspects of the invention.

FIG. 3 illustrates a flow chart depicting a method suitable for carrying out one or more aspects of the invention described herein.

FIG. 4 illustrates a use case scenario wherein one or more illustrative aspects of the invention may be practiced.

FIG. 5 illustrates an object recognition and interactivity diagram suitable for carrying out one or more illustrative aspects of the invention.

FIG. 6 illustrates a connection diagram suitable for carrying out one or more illustrative aspects of the invention.

### DETAILED DESCRIPTION

In the following description of the various embodiments, reference is made to the accompanying drawings, which form a part hereof, and in which is shown by way of illustration various embodiments in which one or more aspects of the invention may be practiced. It is to be understood that other embodiments may be utilized and structural and functional modifications may be made without departing from the scope of the present invention.

Conventional processes for producing and distributing images of one or more objects include the steps of: (1) shooting one or more images of the one or more objects via a camera (e.g., a video camera), (2) uploading the images to a computing platform, (3) transferring/transmitting the images, and (4) viewing the images. The steps of transferring/transmitting the images, and viewing the images, may take place on the same computing platform that performed the step of uploading, or one or more of the steps may take place on more than one computing platform. An optional step of replacing image(s) with one or more models may also be incorporated at any point. These processes, however, fail to provide for real-time interaction or access to one or more objects depicted in either the images or models. Thus, as demonstrated herein, one or more aspects of the invention provide for such real-time access and/or interaction. The phrase “real-time,” as used herein, has been used in the electronic and computer arts to generally relate to the interaction of hardware, software, firmware, or some combination thereof that is subject to a real-time constraint. It is this usage of the phrase that is intended herein.

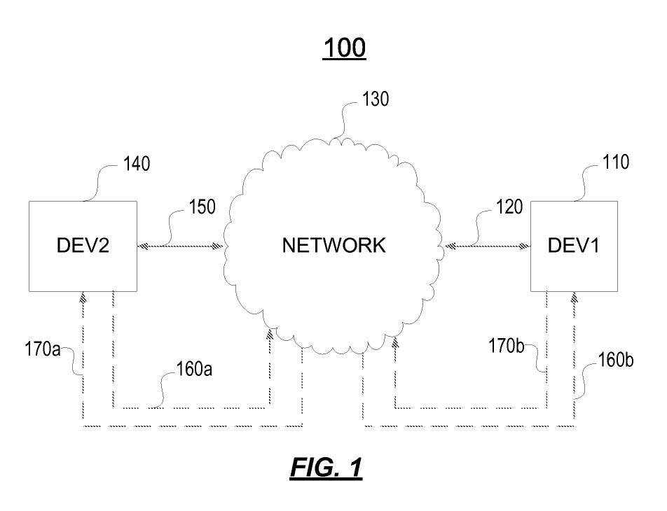

FIG. 1 illustrates a network computing environment 100 suitable for carrying out one or more aspects of the present invention. For example, FIG. 1 illustrates a first device DEV1 110 connected to a network 130 via a connection 120. Network 130 may include the Internet, an intranet, wired or wireless networks, or any other mechanism suitable for facilitating communication between computing platforms in general. FIG. 1 also depicts a second device DEV2 140 connected to network 130 via a connection 150. By virtue of the connectivity as shown, DEV1 110 and DEV2 140 may communicate with one another. Such communications may enable the exchange of various types of information. For example, the communications may include data to be exchanged between DEV1 110 and DEV2 140. Such data may include image files, models, and the like. The communications may further include additional information such as control information.

Connections 120 and 150 illustrate interconnections for communication purposes. The actual connections represented by connections 120 and 150 may be embodied in various forms. For example, connections 120 and 150 may be hardwired/wireline connections. Alternatively, connections 120 and 150 may be wireless connections. Connections 120 and 150 are shown in FIG. 1 as supporting bi-directional communications (via the dual arrow heads on each of connections 120 and 150). Alternatively, or additionally, computing environment 100 may be structured to support separate forward (160a and 160b) and reverse (170a and 170b) channel connections to facilitate the communication.

Computing environment 100 may be carried out as part of a larger network consisting of more than two devices. For example, DEV2 140 may exchange communications with a plurality of other devices (not shown) in addition to DEV1 110. The communications may be conducted using one or more communication protocols. Furthermore, computing environment 100 may include one or more intermediary nodes (not shown) that may buffer, store, or route communications between the various devices.

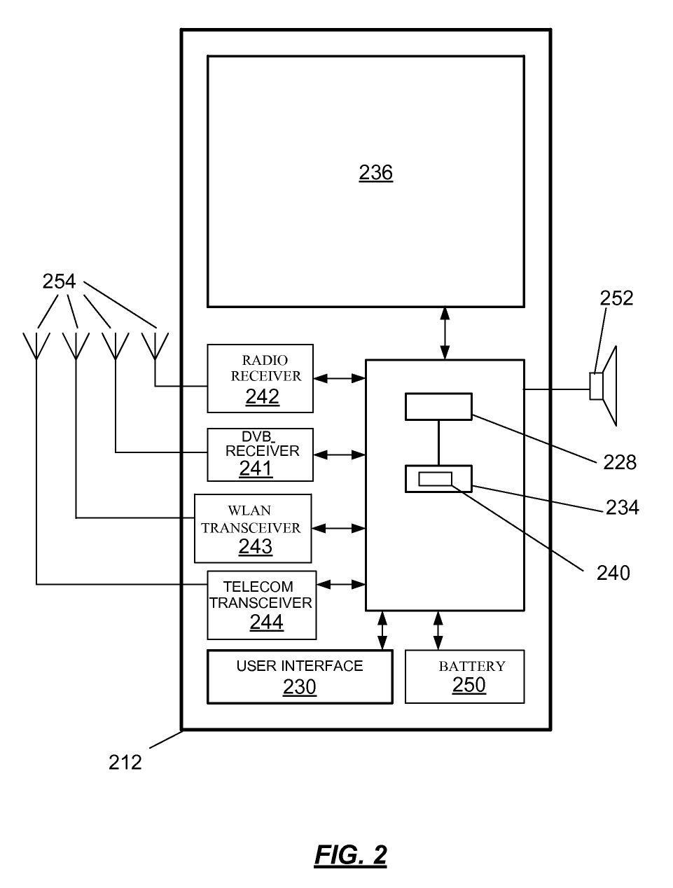

FIG. 2 illustrates a generic computing device 212, e.g., a desktop computer, laptop computer, notebook computer, network server, portable computing device, personal digital assistant, smart phone, mobile telephone, cellular telephone (cell phone), terminal, distributed computing network device, or any other device having the requisite components or abilities to operate as described herein. As shown in FIG. 2, device 212 may include processor 228 connected to user interface 230, memory 234 and/or other storage, and display 236. Device 212 may also include battery 250, speaker 252 and antennas 254. User interface 230 may further include a keypad, touch screen, voice interface, four arrow keys, joy-stick, stylus, data glove, mouse, roller ball, touch screen, or the like. In addition, user interface 230 may include the entirety of or portion of display 236.

Computer executable instructions and data used by processor 228 and other components within device 212 may be stored in a computer readable memory 234. The memory may be implemented with any combination of read only memory modules or random access memory modules, optionally including both volatile and nonvolatile memory. Software 240 may be stored within memory 234 and/or storage to provide instructions to processor 228 for enabling device 212 to perform various functions. Alternatively, some or all of the computer executable instructions may be embodied in hardware or firmware (not shown).

Furthermore, the computing device 212 may include additional hardware, software and/or firmware to support one or more aspects of the invention as described herein. For example, computing device 212 may include a camera (not shown) and/or audiovisual (e.g., movie/film) support software/firmware. Device 212 may be configured to receive, decode and process digital broadband broadcast transmissions that are based, for example, on the Digital Video Broadcast (DVB) standard, such as DVB-H, DVB-T or DVB-MHP, through a specific DVB receiver 241. The mobile device may also be provided with other types of receivers for digital broadband broadcast transmissions. Additionally, device 212 may also be configured to receive, decode and process transmissions through FM/AM Radio receiver 242, WLAN transceiver 243, and telecommunications transceiver 244. In at least one embodiment of the invention, device 212 may receive radio data stream (RDS) messages.

Computer program product implementations may include a series of computer instructions fixed either on a tangible medium, such as a computer readable storage medium (e.g., a diskette, CD-ROM, ROM, DVD, fixed disk, etc.) or transmittable to computer device 212, via a modem or other interface device, such as a communications adapter connected to a network over a medium, which is either tangible (e.g., optical or analog communication lines) or implemented wirelessly (e.g., microwave, infrared, or other transmission techniques). The series of computer instructions may embody all or part of the functionality with respect to the computer system, and can be written in a number of programming languages for use with many different computer architectures and/or operating systems, as would be readily appreciated by one of ordinary skill. The computer instructions may be stored in any memory device (e.g., memory 234), such as a semiconductor, magnetic, optical, or other memory device, and may be transmitted using any communications technology, such as optical infrared, microwave, or other transmission technology. Such a computer program product may be distributed as a removable medium with accompanying printed or electronic documentation (e.g., shrink wrapped software), preloaded with a computer system (e.g., on system ROM or fixed disk), or distributed from a server or electronic bulletin board over a network (e.g., the Internet or World Wide Web). Various embodiments of the invention may also be implemented as hardware, firmware or any combination of software (e.g., a computer program product), hardware and firmware. Moreover, the functionality as depicted may be located on a single physical computing entity, or may be divided between multiple computing entities.

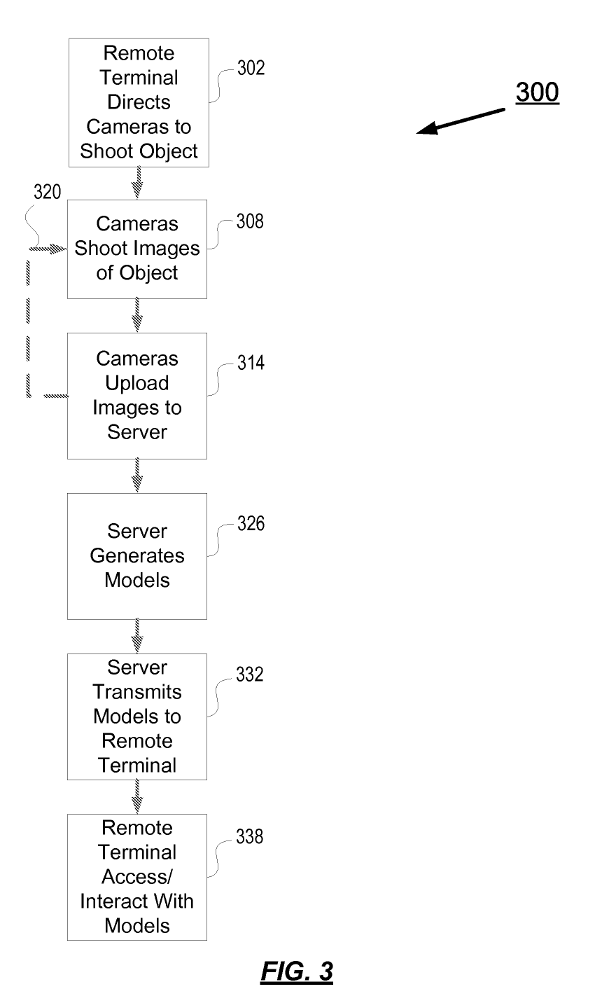

FIG. 3 depicts a flow chart describing a method 300 suitable for carrying out one or more operations as described herein. Method 300 may be executed on any suitable computing platform (e.g., computing device 212). More specifically, method 300 may be executed in conjunction within a (web) browser or the like.

In step 302, a remote terminal (e.g., computing device 212) may issue a directive to command one or more cameras to shoot/photograph an object. The directive may be transmitted directly to the one or more cameras. Alternatively, or additionally, the directive may be transmitted to a server (optionally by way of one or more intermediary devices, e.g., a router), and the server may forward the directive (either directly, or via a functional equivalent to the directive) to the one or more camera(s). The directive may further include information related to establishing a control and/or access focus with respect to the object as will be described later herein. The object to be shot/photographed may be selected by a user (e.g., via actuation of one or more keys or buttons on computing device 212). Alternatively, or additionally, the selection may take place automatically (e.g., in accordance with a profile or predefined setting).

In step 308, the one or more cameras may take/shoot one or more images of the selected object. The number of images to be taken may be based on a number of considerations. For example, the number of images to be taken may be based on the complexity of the selected object; a more complex object may require a greater (e.g., proportionally greater) number of images to be taken to capture the selected object's features or characteristics. The number of images to be taken may be related to the quality of the camera(s) used, or more specifically, the quality of the images produced by the camera(s) used. As the quality of a camera(s) improves, fewer images may be required. In at least one embodiment, the images are transmitted/transferred across one or more computing networks. As such, it may be desirable to minimize the number of transmitted/transferred images so as to minimize the amount of bandwidth consumed.

In step 314, the one or more cameras may upload the one or more images to a server. The camera(s) may initiate an upload sequence after each image is shot/photographed. This may be desirable when there is a requirement that the images be of a high quality (e.g., a high resolution), or where memory constraints on a particular camera are such that storing one or more of the images is infeasible. This scenario is depicted in FIG. 3 via broken line/arrow 320, which reflects the notion that images may be taken and then subsequently uploaded, and the process may repeat itself in a “looping” manner. Alternatively, or additionally, the one or more cameras may buffer or store images in memory (e.g., memory 234), and then may upload the images in one or more bursts. This may be particularly advantageous where there are a large number of cameras in a system, where the system imposes bandwidth considerations/limitations, or where the server is engaged in operations with multiple clusters of objects, cameras, or users. More specifically, by engaging in a burst mode of operation, signaling or protocol overhead may be minimized on a per image (upload) basis.

In step 326, the server (or possibly another computing device, e.g., computing device 212) generates one or more 3D models based on the images. Based on these 3D models of rooms, places and other scenarios, objects can be detected, tracked, highlighted and/or displayed in a photographic or abstracted manner. The models of the objects may contain relevant information for actions that they can perform or which may be performed using them. The information may be organized as parameters, and may include interface type parameters. The information may also convey an indication of a position and orientation of objects in a current model of the room. Parameters related to position and orientation may characterize an object's absolute position, history (e.g., translational history), and the like. The complexity of models may vary based on one or more characteristics of an object (e.g., rigid or non-rigid object) and/or the intended use of the models (e.g., the types of applications the models are intended for). The server may generate a model for each image received (e.g., a one-to-one correspondence). Alternatively, or additionally, the server may generate multiple models from each image, or the server may combine multiple images to form each model. A model may be static in nature, reflecting the state of the object at a specific instant in time. Alternatively, or additionally, the models may reflect the state of the object over a longer period of time, and may convey a sense of how animated the object is. The models may incorporate visual, audio, textual, or any other characteristics associated with the object. The models themselves may be saved as files or the like, and may be stored in one or more memory devices.

In step 332, the server may transmit/transfer the models (e.g., model files) to the remote terminal. The transfer may be initiated via a directive or request issued from the remote terminal. Alternatively, or additionally, the server may push one or more models at the time the models become available (e.g., immediately after they are generated). Similar to the transfer of the images from the camera(s) to the server discussed previously, the models may be transmitted individually, or alternatively, they may be transferred in a grouping with other models via one or more bursts. Individual transfers of each model may be desirable in time-sensitive applications, where there is a desire or need to acquire models as quickly as possible. Conversely, in scenarios where an application is not so time-sensitive, or where the application mandates a more judicious utilization of bandwidth, a model may be transferred along with other models as a member/element of a (burst) group.

In step 338, the remote terminal receives (and optionally saves) the models, and accesses or otherwise interacts with the models. The access or interaction may take place automatically (e.g., in accordance with one or more predetermined settings). Alternatively, the access or interaction may take place with a user engaging the remote terminal via one or more input commands, and obtaining feedback responsive to the one or more commands. For example, in an application related to surveillance of a beachfront home, a model may be received showing the height of the sea water and/or how far the sea is relative to the exterior of the home. The remote terminal may be configured to trigger an alarm (e.g., an audio alert via speaker 252, and/or a graphical message generated on display 236), to alert a user of recent developments (e.g., the sea is advancing towards the home and there is only sixty feet (or some other amount) of beach sand between the home and the sea). Alternatively, the remote terminal may be configured to respond to the changing sea conditions by automatically directing one or more of the cameras (away from other objects/areas, e.g., the front driveway) to the advancing sea (e.g., method 300 may repeat itself with the focus of the cameras specifically targeted to the sea). In at least one embodiment, instead of the redirection of the cameras taking place automatically, a user may instead command the cameras to focus on the sea. The user may receive a confirmation indicating the redirection of the cameras to the sea. The confirmation may be an affirmative confirmation in the form of a text message or the like to be displayed on the remote terminal. Alternatively, the confirmation may be more passive in nature, and may take the form of an increasing number of the models being focused on the sea in comparison to the number of models received relating to other objects/areas.

Method 300 is illustrative, and it is to be understood that modifications may be made without departing from the spirit and scope of the method. For example, an intervening server may not be present, and instead, the images may be transmitted directly from the camera(s) to the remote terminal. The transformation operation/function that converts the images into models may be located at the camera(s), the server, or the remote terminal, or in some combination thereof.

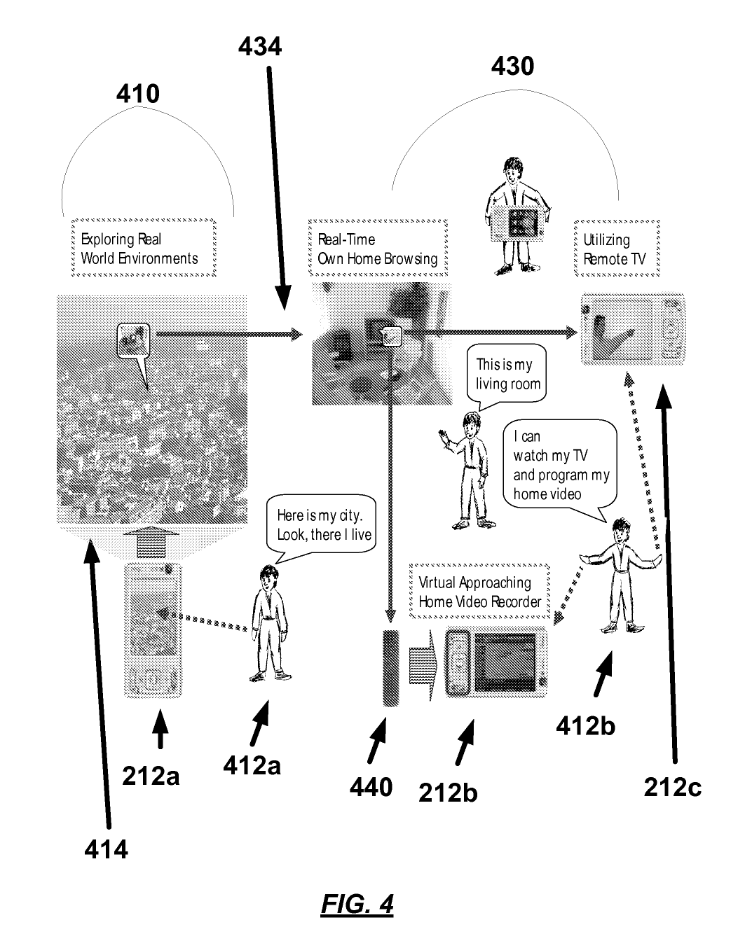

FIG. 4 illustrates in block diagram form a use case scene suitable for demonstrating one or more aspects of the invention as described herein. FIG. 4 depicts two sub-scenes, first sub-scene 410 and second sub-scene 430. In first sub-scene 410, a user 412a using a computing device 212a (e.g., a mobile terminal) may desire to take a look in on the city (e.g., Chicago, Ill.) in which he lives. For example, user 412a may be away from home while on a business trip (e.g., at a wireless networking seminar in San Jose, Calif.), but may want to learn what the current traffic conditions are like in Chicago. More specifically, user 412a may be nervous that the last time he parked his car on the street in Chicago, he didn't park close enough to the curb, and that another driver may hit his car as a result. Thus, using device 212a, user 412a may pull up on a display (e.g., display 236) a model 414 of Chicago. Model 414 may have initially been captured as or more images via one or more cameras (not shown), and then undergone a transformative process to convert the one or more images into model 414 as shown. Using one or more images and/or models, user 412a may subsequently drill down from model 414 of Chicago to a finer resolution so as to depict his home neighborhood and/or street.

User 412a, after checking up on his car to ensure that no property damage has taken place, may desire to check in on his home to ensure that nobody has broken in or robbed him. Thus, in sub-scene 430, a model 434 of a living room is presented on a display (e.g., display 236) of device 212b. Comforted that nothing has been taken out of his living room, user 412b may want to find out what else is going on in and around his Chicago neighborhood by watching an episode of the Chicago local news. The episode itself may have been recorded previously, or it may be a live broadcast. Thus, user 412b may direct one or more home cameras (not shown) to refine their focus (e.g., by zooming-in) from the living room to a television and/or recording equipment located in the living room. This (re)direction may take the form of a directive issued from device 212b, or more specifically, the directive may be issued responsive to the actuation of one or more keys or buttons located on device 212b. Device 212b may be configured such that the interface that user 412b is presented with mirrors a control interface that user 412b is accustomed to when using a remote control 440 in conjunction with the referenced television and/or recording equipment while at home. As a result, user 412b may utilize control menus or the like via device 212b to obtain access to the referenced Chicago local news (displayed on device 212c in FIG. 3), with the same ease as if user 412b was sitting in his leather recliner in his living room. User 412b may also use device 212b so as to setup the television and/or recording equipment to tape/record an episode to take place in the future. More generally, user 412b may control one or more functions or behaviors associated with the television and/or recording equipment. Alternatively, or additionally, the various menus presented on device 212 (e.g., device 212b) may be presented without the need to use a camera and/or turn on the television and/or recording equipment. For example, video streams from set-top boxes, television, and/or recording equipment may be sent directly to device 212 without displaying the video streams on the television or recording the video footage via a camera.

The above example demonstrated zooming-in from a living room setting to the referenced television and/or recording equipment. It is understood that the zoom features may enable access or interaction at any level of granularity. For example, a user (e.g., user 412b) having selected a television may continue to zoom-in further to specifically target a color contrast button that may be present on the television. Thus, the user may gain access to or otherwise modify or adjust the color contrast of the picture he receives on a remote terminal (e.g., device 212b) by way of the television. Thereafter, the user may subsequently zoom-out from the color contrast button back to the television so as to regain access to the television as a whole.

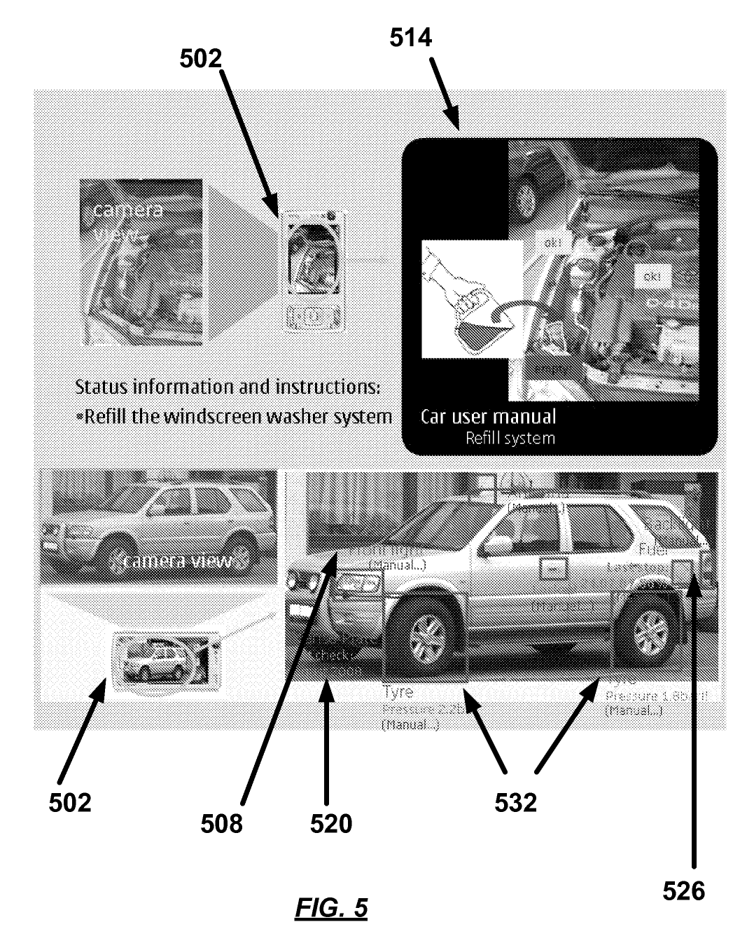

The nature of the interaction with an object may facilitate replacing old and out-dated printed user manuals with dynamic real-time instruction. In one example, FIG. 5 illustrates an object recognition and interactivity diagram wherein a mobile terminal provides instruction how to solve a problem associated with automobile maintenance and repairs. A mobile terminal 502 (e.g., device 212) may be configured to communicate electronically with automobile 508. The communication may take place via short range connectivity, such as via Bluetooth, 802.11, etc.

Once a communication channel is established between mobile terminal 502 and automobile 508, automobile 508 may transmit status or warning information identifying a problem associated with automobile 508. For example, automobile 508 may transmit warning information identifying that the motor oil is below a minimum threshold, that the windscreen washer fluid has been depleted, or the like. The information may also convey a sense of how urgent it is to seek out or obtain repairs. The information may take the form of a text message, an audio message, or the like.

Mobile terminal 502 may receive the warning information transmitted by automobile 508. A user of mobile terminal 502 might not be a skilled automobile mechanic, and may require additional assistance to effectuate the repairs. Mobile terminal 502 may display a picture 514 showing the general problem area. Mobile terminal 502 may also display instructions as to how to remedy the problem. For example, picture 514 instructs a user to apply windscreen washer fluid to an appropriate receptacle because the receptacle is empty. Picture 514 may also convey (via “ok” status messages) to the user that the surrounding compartments/devices are functioning properly. Picture 514 may be taken/shot by mobile terminal 502. Picture 514 and/or the instructions as to how to remedy the problem may be stored in the mobile terminal 502. Alternatively, picture 514 and/or the instructions as to how to remedy the problem may be stored in automobile 508 and transmitted to mobile terminal 502. Furthermore, picture 514 and/or the instructions as to how to remedy the problem may be stored on a server (database) or the like and transmitted to the mobile terminal over the Internet. The instructions may further include voice/audio instructions, motion pictures (e.g., video) and the like. The instructions may be updated responsive to a user taking action. For example, if an initial instruction recommended filling a windscreen washer fluid receptacle, mobile terminal 502 may receive updated instructions indicating how much additional fluid is required after a user has begun filling the receptacle. Mobile terminal 502 may also receive an indication (e.g., an “ok” status message) once the receptacle has been filled with fluid to an appropriate level, or when the problem has otherwise been remedied.

Picture 520 shows additional information that may be presented on the display of mobile terminal 502. For example, in reference to fuel/gas tank 526, information may be presented to the user showing the last time the gas was deposited in the gas tank. The information may further include the quantity/volume of gas deposited and how much fuel is remaining in the gas tank. Tire/Tyre pressures 532 associated with the automobile 508 may also be shown on mobile terminal 502. Additional status information related to automobile 508 may also be displayed on mobile terminal 502.

Access to the images and/or models may be granted responsive to a user request to obtain them (e.g., a pull mode of operation). Alternatively, or additionally, the images and/or models may be forwarded to a user when they become available (e.g., a push mode of operation). A user may also setup a profile or the like to enable the user to establish preferences as to the types of objects the user is interested in, when or how often the user would like to be granted access to the images and/or models, and the like. Thus, a filtering function may be setup to control or otherwise regulate the nature of the access or interaction with the images or models.

Access to one or more images or models may be restricted so as to preserve security interests. For example, a user (e.g., user 412b) may restrict access to his living room to himself and those in his immediate family. The access may be regulated via an authorization scheme, such as the authentication of an entered username and password, a Personal Identification Number (PIN), or the like. Conversely, model 414 depicting the City of Chicago may be available to the general public. The models may be provided responsive to payment of a subscription fee.

A connection between device 212 and the various objects to be displayed may take place using information such as IP-addresses assigned to the objects, which may be accessed from a related database. The connection itself may then be established using the Universal Plug and Play (UPnP) protocol, web services, or the like. As soon as a connection to the (remote) object is established, the user interface (UI) may be transferred to device 212.

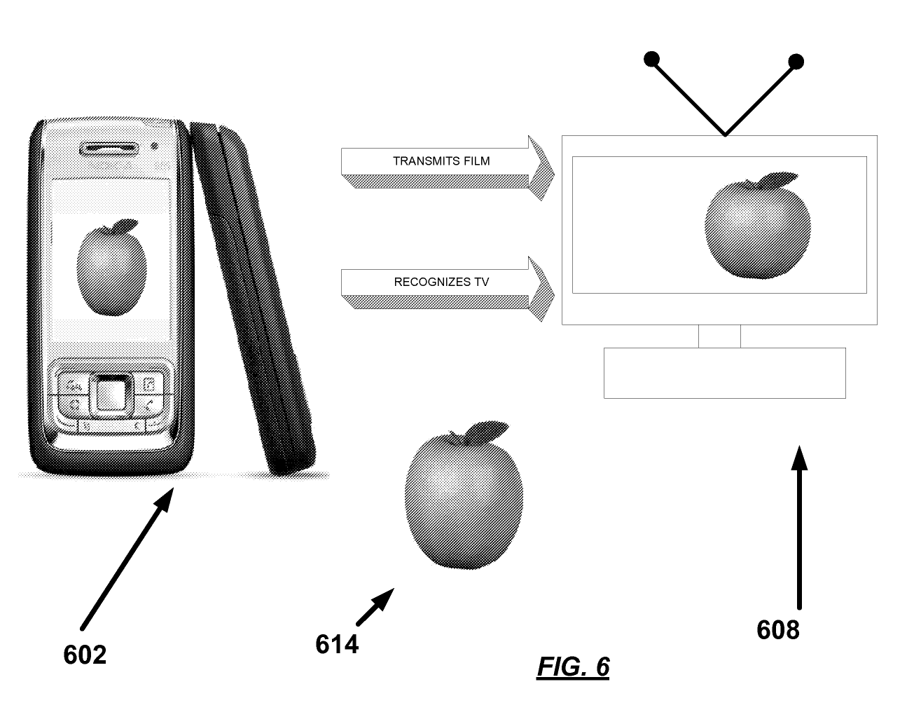

FIG. 6 illustrates a connection diagram that may be used to facilitate a connection between a source device (e.g., mobile terminal 602) and an object (e.g., television 608). Mobile terminal 602 may have a camera to help facilitate establishing the connection. For example, mobile terminal 602 may be directed toward television 608, and mobile terminal 602 may take a picture of television 608. Responsive thereto, mobile terminal 602 may establish a connection with television 608.

The connection between mobile terminal 602 and television 608 may be established based on address information indicated on or by television 608. For example, a manufacturer of television 608 may label the exterior of television 608 with information relating to fixed IP address(es), Bluetooth name(s), and the like. Alternatively, television 608 can be configured to transmit an infrared light message that includes an IP address, a Bluetooth name or the like. Mobile terminal 602 may be configured to receive the infrared message and establish a connection responsive thereto. Furthermore, television 608 may be assigned a unique worldwide code, and the code may be included on the exterior of television 608. Mobile terminal 602 may read the code and transmit that information to a server (not shown), a web-based database or the like. The server may return associated connection parameters and/or technology information to mobile terminal 602. Given the preceding, a user is not required to know specific technical information related to connection addresses, communication protocols, (wireless) technology, and the like. Instead, mobile terminal 602 and/or television 608 may identify the relevant information, such as application requirements, required data rate, and available wireless technologies (e.g., WLAN, Bluetooth, WiMAX) to facilitate the connection. As such, a user is alleviated from having to explicitly interact with mobile terminal 602 to establish the connection.

In accordance with the point-and-connect technology demonstrated with respect to FIG. 6, one of ordinary skill in the art will appreciate numerous illustrative scenarios wherein the technology may be incorporated. For example, as shown in FIG. 6, mobile terminal 602 may take a picture of an apple 614 and transmit the picture to television 608. In another example, a customer at an electronics store may point his mobile terminal at a printer or speaker system out on the showroom floor. The printer may subsequently print pictures stored on the mobile terminal, or the speaker system may play music files (e.g., mp3 files) stored on the mobile terminal. The mobile terminal may also be configured to receive sample movies/songs from one or more pieces of equipment located in the store. The mobile terminal may further be configured to check or compare offers between the goods sold in the store and other outlets.

The mobile terminal may also find uses in the home. Control over climate control equipment (e.g., a furnace or air conditioning unit) may be provided. Alternatively, or additionally, status may be received with respect to one or more appliances (e.g., a status message may be received indicating that all appliances are switched off). Surveillance of the premises may also be provided, and one or more warning or status messages may be received at the mobile terminal. The warning or status messages may include audio sounds, text messages, pictures, videos, and the like. In the kitchen, the mobile terminal may be configured to check and synchronize to a family calendar, obtain a shopping list placed on a refrigerator, post a virtual note to the refrigerator, and check where family members are located. In the living room, the mobile terminal may be configured to connect and communicate with a remote control associated with a television or a stereo. The mobile terminal may be configured to upload and/or download movies or music files to/from the television or stereo. The mobile terminal may be configured to transmit a photo image to a picture frame.

Business applications may be enhanced using the point-and-connect technology described above. For example, in an office environment the mobile terminal may be configured to issue a print command to a printer. The mobile terminal may be configured to contact a colleague or setup an appointment/meeting.

The subject matter described herein clearly conveys a number of benefits and enhancements in comparison to the state of the prior art. These benefits include the ability to interact with and access one or more objects in real-time via one or more images and/or models. The presentation of user interfaces native to those objects on a computing device (e.g., a remote terminal) is more intuitive and user friendly, since a user will have become accustomed to using those user interfaces. Furthermore, no changes are required with respect to the available hardware needed. Thus, the technology may be characterized as a “green technology,” because remote devices may be used instead of requiring the installation of new devices at a user's local site.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
a remote terminal directing a camera to shoot an image of an object;
the remote terminal receiving a real-time model of the object based on the image;
receiving a command to access the object based on the real-time model; and
accessing the object responsive to the command.

2. The method of claim 1, wherein the method further includes a step of controlling the object responsive to the command.

3. The method of claim 1, wherein the method further includes a step of refining a focus of the camera, wherein the step of refining includes modifying a granularity at which the camera shoots the image of the object.

4. The method of claim 3, wherein a degree of access to the object changes responsive to the modification of the granularity at which the camera shoots the image of the object.

5. The method of claim 1, wherein the method further includes an authorization scheme, wherein the authorization scheme includes the steps of:
entering data; and
authenticating the data,
wherein the data includes either a username and password or a personal identification number (PIN).

6. The method of claim 1, wherein the model is transmitted to the remote terminal immediately when the model becomes available.

7. The method of claim 1, wherein the model is transmitted to the remote terminal with at least one additional model as a burst.

8. The method of claim 1, wherein the command is generated responsive to a predetermined setting.

9. The method of claim 1, wherein the method includes displaying a user interface native to the object on the remote terminal.

10. An apparatus comprising:
a processor; and
a memory for storing computer readable instructions that, when executed by the processor, cause the apparatus to:
direct a camera to shoot an image of an object;
request a model of the object to be sent to the apparatus;
receive a model of the object responsive to the request;
receive at least one input command; and
interact with the object in real-time responsive to the at least one input command.

11. The apparatus of claim 10, wherein the model is a three dimensional rendering of the object.

12. The apparatus of claim 10, wherein the computer readable instructions further include an instruction to refine a focus of the camera, and wherein the instruction to refine a focus of the camera causes the apparatus to modify a granularity at which the camera shoots the image of the object.

13. The apparatus of claim 12, wherein a degree of interaction with the object changes responsive to the modification of the granularity at which the camera shoots the image of the object.

14. The apparatus of claim 10, wherein the computer readable instructions further include at least one instruction implementing an authorization scheme, wherein the authorization scheme includes a request to enter data, and responsive to receiving entered data, authenticating the entered data, wherein the data includes either a username and password or a personal identification number (PIN).

15. The apparatus of claim 10, wherein the computer readable instructions include an instruction to display on the apparatus a user interface native to the object.

16. A system comprising:
a camera;
a server; and
a remote terminal device;
wherein the remote terminal device is configured to:
transmit a directive to the camera to establish a focus on an object;
receive a model of the object;
receive at least one input command that serves to control the object; and
transmit the at least one input command, and
wherein the server is configured to:
receive an image of the object taken by the camera;
generate a model of the object based on the image; and
transmit the model to the remote terminal device, and
wherein a functionality of the object is controlled responsive to the at least one input command.

17. The system of claim 16, wherein the at least one input command includes a command to shoot an image.

18. The system of claim 16, wherein a user interface native to the object is displayed on the remote terminal device.

19. The system of claim 18, wherein the input command is received via an interaction with the user interface native to the object that is displayed on the remote terminal device.

20. The system of claim 16, wherein the remote terminal is further configured to receive images of the object as soon as they become available.

21. A method comprising:
establishing at a remote terminal a connection with an object;
receiving at the remote terminal an identification of a problem with the object;
receiving at the remote terminal a first set of instructions as to how to remedy the problem; and
receiving at the remote terminal a second set of instructions as to how to remedy the problem responsive to a user interaction with the object based on the first set of instructions,
wherein the first set of instructions and the second set of instructions are different instructions.

22. The method of claim 21, wherein each of the first and second set of instructions include at least one of a picture, video, or audio instructions.

23. The method of claim 21, wherein the method further includes receiving at the remote terminal an indication that the problem with the object has been remedied.

24. A method comprising:
determining at a remote terminal that an object is able to connect with the remote terminal;
analyzing at the remote terminal application requirements and available wireless technologies; and
establishing a connection at the remote terminal with the object via a connection address based on the application requirements and the available wireless technologies.

25. The method of claim 24, wherein the determination at a remote terminal that an object is able to connect with the remote terminal is based on at least one of: reading an available connection address printed on the exterior of the object, receiving an infrared light message from the object including an available connection address, or receiving an available connection address from a database responsive to a remote terminal request.

26. One or more computer readable media storing computer executable instructions that, when executed, configure an apparatus to provide access to an object by:
directing a camera to shoot an image of the object;
receiving a real-time model of the object based on the image;
receiving a command to access the object based on the real-time model; and
accessing the object responsive to the command.

27. The one or more computer readable media of claim 26, wherein the one or more computer readable media further store computer executable instructions that, when executed, change a degree of access to the object responsive to a modification of a granularity at which the camera shoots the image of the object.

28. The one or more computer readable media of claim 26, wherein the one or more computer readable media further store computer executable instructions that, when executed, causes a remote terminal to display a user interface native to the object on the remote terminal.
